(19) United States
(12) Patent Application Publication
(10) Pub. No.: US 2023/0260703 A1
(43) Pub. Date: Aug. 17, 2023

(54) DIELECTRIC CERAMIC COMPOSITION

(71) Applicant: TDK CORPORATION, Tokyo (JP)

(72) Inventors: Shinichi SASAKI, Tokyo (JP); Kazuya MUTO, Tokyo (JP); Akira SATO, Tokyo (JP)

(73) Assignee: TDK CORPORATION, Tokyo (JP)

(21) Appl. No.: 18/077,664

(22) Filed: Dec. 8, 2022

(30) Foreign Application Priority Data
Feb. 14, 2022 (JP) 2022-020707

(51) Int. Cl. H01G 4/12; C04B 35/468

(52) U.S. Cl. CPC H01G 4/1227; C04B 35/4682; C04B 2235/3236; C04B 2235/3272; C04B 2235/3262; C04B 2235/3251; C04B 2235/3256; C04B 2235/3258; C04B 2235/3293; C04B 2235/3298; C04B 2235/3227; C04B 2235/3275; C04B 2235/3284; C04B 2235/3279; C04B 2235/3241; C04B 2235/3217; C04B 2235/3409; C04B 2235/3418

(57) ABSTRACT

A dielectric ceramic composition includes main component grains having a perovskite structure represented by a formula AMO₃. “A” includes Ba. “M” includes Ti. The dielectric ceramic composition includes a 4A subcomponent. The 4A subcomponent includes Fe and Mn. A molar ratio of Mn to a total of Fe and Mn in terms of a metal element is 0.18 to 0.65.

The present application claims a priority on the basis of Japanese patent application No. 2022-020707 filed on Feb. 14, 2022, which is incorporated herein by reference in its entirety.

### TECHNICAL FIELD

The present invention relates to a dielectric ceramic composition.

### BACKGROUND

For example, Japanese Laid-Open Patent Publication No. S63-102105 discloses a dielectric ceramic composition including niobium oxide, cobalt oxide, and manganese oxide to achieve high permittivity.

Unfortunately, the dielectric ceramic composition disclosed in Japanese Laid-Open Patent Publication No. S63-102105 has a low value of the AC breakdown electric field.

### SUMMARY

The present invention has been achieved under such circumstances. It is an object of the invention to provide a dielectric ceramic composition capable of maintaining high insulation resistance and having a high value of the AC breakdown electric field.

A dielectric ceramic composition according to the present invention is a dielectric ceramic composition including main component grains having a perovskite structure represented by a formula AMO₃, wherein

“A” includes Ba,
“M” includes Ti,
the dielectric ceramic composition includes a 4A subcomponent,
the 4A subcomponent includes Fe and Mn, and
a molar ratio of Mn to a total of Fe and Mn in terms of a metal element is 0.18 to 0.65.

The dielectric ceramic composition according to the present invention can maintain high insulation resistance and have a high value of the AC breakdown electric field.

The dielectric ceramic composition according to the present invention preferably further includes 0 to 10 parts by mol of a second subcomponent with respect to 100 parts by mol of “M” in terms of a metal element, and the second subcomponent preferably includes at least one selected from the group consisting of Nb, Mo, Ta, W, Sn, and Bi.

This increases the relative permittivity of the dielectric ceramic composition.

The dielectric ceramic composition according to the present invention preferably further includes 0.01 to 2 parts by mol of a third subcomponent with respect to 100 parts by mol of “M” in terms of a metal element, and the third subcomponent preferably includes at least one selected from the group consisting of Sm, Nd, and La.

This improves the temperature characteristics of capacitance of the dielectric ceramic composition. This means that the dielectric ceramic composition has a small absolute value of the rate of change of capacitance (TC).

The dielectric ceramic composition according to the present invention may further include a 4B subcomponent, and the 4B subcomponent may include at least one selected from the group consisting of Co, Zn, Ni, and Cr.

The dielectric ceramic composition according to the present invention preferably further includes 0.02 to 2.2 parts by mol of the 4A subcomponent and the 4B subcomponent in total with respect to 100 parts by mol of “M” in terms of a metal element.

This improves the temperature characteristics of capacitance of the dielectric ceramic composition.

The dielectric ceramic composition according to the present invention preferably further includes 0.08 part by mol or more of a sixth subcomponent with respect to 100 parts by mol of “M” in terms of a metal element, and the sixth subcomponent preferably includes at least one selected from the group consisting of Si, Al, and B.

This further improves the value of the AC breakdown electric field of the dielectric ceramic composition.

A molar ratio of a total of Ba, Ca, and Sr to a total of Ti and Zr in terms of a metal element in the dielectric ceramic composition according to the present invention is preferably 0.98 to 1.02.

This can further improve the relative permittivity, the insulation resistance, and the value of the AC breakdown electric field and reduce the dielectric loss of the dielectric ceramic composition.

The dielectric ceramic composition according to the present invention preferably further includes 0 to 3 parts by mol of a 5A subcomponent with respect to 100 parts by mol of “M” in terms of a metal element, the 5A subcomponent preferably includes at least one selected from the group consisting of Ba, Ca, and Sr, the dielectric ceramic composition preferably further includes 0 to 2.5 parts by mol of a 5B subcomponent with respect to 100 parts by mol of “M” in terms of a metal element, and the 5B subcomponent preferably includes at least one selected from the group consisting of Ti and Zr.

This can further improve the relative permittivity, the insulation resistance, and the value of the AC breakdown electric field and reduce the dielectric loss of the dielectric ceramic composition. This also means that, even when a molar ratio (A/M) of “A” to “M” in raw materials of the main component fluctuates, it is still possible to improve the relative permittivity, the insulation resistance, and the value of the AC breakdown electric field and reduce the dielectric loss provided that the molar ratio {(Ba+Ca+Sr)/(Ti+Zr)} of the total of Ba, Ca, and Sr to the total of Ti and Zr of the dielectric ceramic composition in terms of a metal element is controlled within the preferable range by addition of the 5A subcomponent and/or the 5B subcomponent. In other words, although a preferable range of the addition amounts of the 5A subcomponent and the 5B subcomponent may change in accordance with the molar ratio (A/M) of the raw materials of the main component, the preferable range of the molar ratio {(Ba+Ca+Sr)/(Ti+Zr) } of the dielectric ceramic composition does not change.

The dielectric ceramic composition according to the present invention preferably further includes less than 0.3 part by mol of a first subcomponent with respect to 100 parts by mol of “M” in terms of a metal element, and the first subcomponent is preferably Mg.

This improves the temperature characteristics of capacitance of the dielectric ceramic composition.

An electronic device according to the present invention includes a dielectric layer containing the above-mentioned dielectric ceramic composition.

The electronic device according to the present invention is not limited to particular devices. Examples of the electronic device according to the present invention include a single layer ceramic capacitor or a multilayer ceramic capacitor.

### BRIEF DESCRIPTION OF THE DRAWING(S)

FIG. 1 is a front view of a ceramic capacitor according to an embodiment of the present invention.

FIG. 2 is a side cross-sectional view of the ceramic capacitor according to the embodiment of the present invention.

### DETAILED DESCRIPTION

### Ceramic Capacitor 2

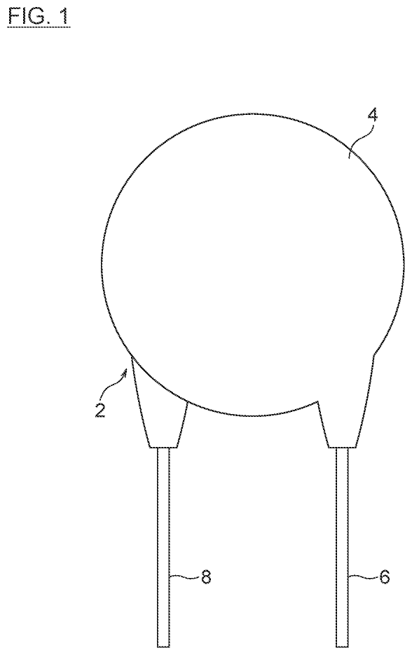

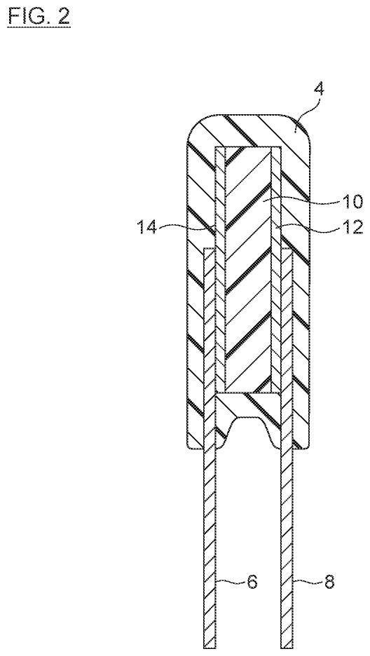

FIGS. 1 and 2 show a ceramic capacitor 2 as an example of an electronic device according to the present embodiment. As shown in FIGS. 1 and 2, the ceramic capacitor 2 according to the present embodiment includes a dielectric layer 10, a pair of terminal electrodes 12 and 14 formed on surfaces of the dielectric layer 10 facing each other, and lead terminals 6 and 8 connected to the terminal electrodes 14 and 12 respectively. These constituents of the ceramic capacitor 2 are covered by a protective resin 4.

The shape of the ceramic capacitor 2 is appropriately determined based on the purpose and usage. The ceramic capacitor 2 is preferably a single layer capacitor whose dielectric layer 10 has a disc shape. The size of the ceramic capacitor 2 is appropriately determined based on the purpose and usage. The ceramic capacitor 2 has a diameter of preferably 3 to 20 mm, more preferably 5 to 20 mm, and still more preferably 5 to 15 mm.

The terminal electrodes 12 and 14 include a conductive material. Examples of the conductive material of the terminal electrodes 12 and 14 include Cu, Cu alloys, Ag, Ag alloys, and In—Ga alloys.

The dielectric layer 10 may have any thickness. The thickness of the dielectric layer 10 is appropriately determined based on the purpose or so, and is preferably 0.1 to 3 mm and more preferably 0.3 to 2 mm. Controlling the thickness of the dielectric layer 10 within this range enables the ceramic capacitor 2 to be suitably used at medium and high voltages.

According to the present embodiment, the capacitor can have a smaller size.

The dielectric layer 10 includes a dielectric ceramic composition according to the present embodiment. The dielectric ceramic composition according to the present embodiment includes main component grains having a perovskite structure represented by a formula AMO₃, where “A” is at least one A-site element, “M” is at least one M-site element, and O is oxygen.

The main component of the dielectric ceramic composition means a component occupying 90 mass % or more of the dielectric ceramic composition. The main component grains of the present embodiment are grains including the main component. A subcomponent may be solid-soluted in the main component grains, or the main component grains may have a core-shell structure with the main component and the subcomponent.

“A” includes Ba. “A” may include Ca and/or Sr in addition to Ba.

“M” includes Ti. “M” may include Zr in addition to Ti.

The dielectric ceramic composition according to the present embodiment may include Mg as a first subcomponent. The dielectric ceramic composition according to the present embodiment preferably includes less than 0.3 part by mol and more preferably includes 0 to 0.2 part by mol of the first subcomponent with respect to 100 parts by mol of “M” in terms of the metal element.

The dielectric ceramic composition according to the present embodiment may include a second subcomponent. The second subcomponent includes at least one selected from the group consisting of Nb, Mo, Ta, W, Sn, and Bi.

The dielectric ceramic composition according to the present embodiment preferably includes 0 to 10 parts by mol and more preferably includes 1 to 3 parts by mol of the second subcomponent with respect to 100 parts by mol of “M” in terms of a metal element.

The dielectric ceramic composition according to the present embodiment preferably includes a third subcomponent. The third subcomponent includes at least one selected from the group consisting of Sm, Nd, and La, and is preferably Sm.

The dielectric ceramic composition according to the present embodiment preferably includes 0.01 to 2 parts by mol and more preferably includes 0.3 to 1.5 parts by mol of the third subcomponent with respect to 100 parts by mol of “M” in terms of a metal element.

The dielectric ceramic composition according to the present embodiment includes a 4A subcomponent. The 4A subcomponent includes Fe and Mn.

In the present embodiment, the molar ratio {Mn/(Fe+Mn) } of Mn to the total of Fe and Mn in terms of the metal elements is preferably 0.18 to 0.65 and is more preferably 0.3 to 0.6.

The dielectric ceramic composition according to the present embodiment may include a 4B subcomponent. The 4B subcomponent includes at least one selected from the group consisting of Co, Zn, Ni, and Cr, and is preferably Co.

The dielectric ceramic composition according to the present embodiment preferably includes 0.02 to 2.2 parts by mol and more preferably includes 0.2 to 1.0 part by mol of the 4A subcomponent and the 4B subcomponent in total with respect to 100 parts by mol of “M” in terms of the metal elements.

The dielectric ceramic composition according to the present embodiment preferably includes a 5A subcomponent. The 5A subcomponent includes at least one selected from the group consisting of Ba, Ca, and Sr, and is preferably Sr.

The dielectric ceramic composition according to the present embodiment preferably includes a 5B subcomponent. The 5B subcomponent includes at least one selected from the group consisting of Ti and Zr, and is preferably Ti.

In the dielectric ceramic composition according to the present embodiment, the molar ratio {(Ba+Ca+Sr)/(Ti+Zr)} of the total of Ba, Ca, and Sr to the total of Ti and Zr in terms of the metal elements is preferably 0.98 to 1.02 and is more preferably 0.990 to 1.010. The numerator (Ba+Ca+Sr) of the molar ratio (Ba+Ca+Sr)/(Ti+Zr) indicates the total of “A” of the main component and the 5A subcomponent. The denominator (Ti+Zr) of the molar ratio (Ba+Ca+Sr)/(Ti+Zr) indicates the total of “M” of the main component and the 5B subcomponent.

The dielectric ceramic composition according to the present embodiment preferably includes a sixth subcomponent. The sixth subcomponent includes at least one selected from the group consisting of Si, Al, and B, and is preferably Si and/or Al.

The dielectric ceramic composition according to the present embodiment preferably includes 0.08 part by mol or more, and more preferably includes 0.2 to 1.5 parts by mol of the sixth subcomponent with respect to 100 parts by mol of “M” in terms of a metal element.

### Method of Manufacturing Ceramic Capacitor

Next, a method of manufacturing the ceramic capacitor will be explained.

First, a dielectric ceramic composition powder to be the dielectric layer 10 shown in FIG. 2 after firing is manufactured.

Raw materials of the main component and raw materials of the first to sixth subcomponents are prepared. Any raw materials can be used as the raw materials of the main component. The raw materials of the main component can be appropriately selected from, for example, oxides and complex oxides of the elements of the main component, or various compounds (e.g., carbonate, nitrate, hydroxide, and organic metal compounds) to be these oxides or complex oxides by firing. For example, BaCO₃ and TiO₂ can be used as the raw materials of the main component.

Although the raw materials of the main component may be manufactured by a solid phase method or a liquid phase method (e.g., a hydrothermal synthesis method and an oxalate method), the raw materials of the main component are preferably manufactured by the solid phase method in terms of manufacturing costs.

A molar ratio (“main component raw material A/M”) of “A” to “M” of the raw materials of the main component is not limited to particular values. The molar ratio is, for example, 0.990 to 1.005.

Any raw materials may be used as the raw materials of the first to sixth subcomponents. The raw materials of the first to sixth subcomponents can be appropriately selected from, for example, oxides and complex oxides of the elements of the subcomponents, or various compounds (e.g., carbonate, nitrate, hydroxide, and organic metal compounds) to be these oxides or complex oxides by firing.

As for a method of manufacturing the dielectric ceramic composition according to the present embodiment, first, the raw materials of the main component, or the raw materials of the main component and the raw materials of the subcomponents are mixed, and then mixed in wet manner with a ball mill or so using zirconia balls or the like.

The mixture is granulated and shaped, and the shaped material is calcined in air to give a calcined powder. As for the calcining conditions, for example, the calcining temperature is preferably 1100 to 1300° C. and more preferably 1150 to 1250° C.; and the calcining time is preferably 0.5 to 4 hours.

Next, the calcined powder is pulverized in wet manner with a ball mill or so and is mixed with the raw materials of any remaining subcomponents, and the mixture is dried to give the dielectric ceramic composition powder. Manufacturing the dielectric ceramic composition powder by the solid phase method as described above can reduce manufacturing costs while ensuring desired characteristics.

Next, an appropriate amount of a binder is added to the dielectric ceramic composition powder for granulation. The granulated material is pressed into a disc shape having a predetermined size to give a green compact. The green compact is fired to give a sintered body of the dielectric ceramic composition. Firing may be performed under any conditions. The holding temperature is preferably 1100 to 1400° C. and more preferably 1200 to 1300° C. The firing atmosphere is preferably air.

On main surfaces of the sintered body of the dielectric ceramic composition, terminal electrodes are printed and baked as necessary to form the terminal electrodes 12 and 14. Then, the lead terminals 6 and 8 are joined to the terminal electrodes 14 and 12 respectively by soldering or so. Lastly, the element body is covered by the protective resin 4. This gives the single layer ceramic capacitor 2 shown in FIGS. 1 and 2.

The single layer ceramic capacitor 2 according to the present embodiment manufactured as described above is to be mounted on a printed circuit board or the like via the lead terminals 6 and 8 and used in various electronics.

The dielectric ceramic composition according to the present embodiment includes the main component grains having the perovskite structure represented by the formula AMO₃, where “A” includes Ba and “M” includes Ti, and the 4A subcomponent containing Fe and Mn, where the molar ratio of Mn to the total of Fe and Mn is 0.18 to 0.65. This enables the dielectric ceramic composition to maintain high insulation resistance and have a high value of the AC breakdown electric field.

Hereinabove, one embodiment of the present invention has been explained, but the present invention is not to be limited to the embodiment in any way, and the present invention can be carried out in various different embodiments within the scope of the present invention.

For example, while the above-mentioned embodiment exemplifies a single layer ceramic capacitor having one dielectric layer as an electronic device, an electronic device according to the present invention is not limited to a single layer ceramic capacitor and may be a multilayer ceramic capacitor manufactured by a normal printing method or sheet method using a dielectric paste including the above-mentioned dielectric ceramic composition and an electrode paste.

### Examples

Hereinafter, the present invention will be explained based on more detailed examples, but the present invention is not limited to the examples.

BaCO₃ and TiO₂ were prepared as raw materials of the main component. These raw materials were weighed to satisfy the value of “main component raw material A/M” of each sample shown in Tables 2, 4, 6, 8, 10, 12, 14, and 16 and were mixed in wet manner with a ball mill using purified water as a solvent and zirconia balls.

Next, the mixture was dried. Then, 5 mass % of water was added to the mixture for granulation and shaping. The shaped material was calcined at 1150° C. for two hours in air. The calcined material was coarsely pulverized with a pulverizer and passed through meshes to give a milled powder. First to sixth subcomponents weighed to satisfy a composition shown in Tables 1, 3, 5, 7, 9, 11, 13, and 15 were added to the milled powder, and the mixture was pulverized in wet manner. The pulverized material was dried to give a dielectric ceramic composition powder having a composition shown in Tables 1 to 16.

With respect to 100 parts by mass of the dielectric ceramic composition powder, 10 parts by mass of a polyvinyl alcohol aqueous solution was added. Then, the mixture was granulated and passed through meshes to give a granulated powder. The granulated powder was pressed at 396 MPa to give disc-shaped green compacts having a diameter of 16.5 mm and a thickness of about 1.2 mm.

The green compacts were fired at 1200 to 1300° C. for two hours in air to give disc-shaped sintered bodies.

A Cu electrode paste was applied to both main surfaces of each sintered body (dielectric layer 10) and baked at 800° C. for 10 minutes in a reducing atmosphere to give disc-shaped ceramic capacitor samples as shown in FIGS. 1 and 2. The dielectric layer 10 of each capacitor sample had a thickness of about 1 mm. The baked electrodes of the capacitor sample had a diameter of 12 mm.

The relative permittivity, the dielectric loss, the insulation resistance, the AC breakdown electric field, and the rate of change of capacitance of the capacitor sample were evaluated as follows. Tables 2, 4, 6, 8, 10, 12, 14, and 16 show the results of evaluation.

### Relative Permittivity (εr) and Dielectric Loss (Tan δ)

A signal with a frequency of 1 kHz and an input signal level (measurement voltage) of 1.0 Vrms was applied to the capacitor sample using a digital LCR meter (4278A manufactured by Agilent Technologies) at a reference temperature of 20° C. to measure the capacitance and the dielectric loss. The relative permittivity c (no unit) was calculated using the measured capacitance. Higher relative permittivity was preferable. In the present examples, a relative permittivity of 1500 or more was deemed good.

### Insulation Resistance (IR)

The insulation resistance value was read after DC 500 V was applied to the capacitor sample for 60 seconds using a digital resistance meter (4339B manufactured by Agilent Technologies) at room temperature.

### AC Breakdown Electric Field (ACVB)

An AC electric field of 100 V/s was gradually applied to both ends of the capacitor sample to measure the electric field value as of when a leakage current of 100 mA flowed as the AC breakdown electric field (ACVB). A higher value of the AC breakdown electric field was preferable. In the present examples, a value of 5.0 kV/mm or more was deemed good.

### Rate of Change of Capacitance (TC)

The capacitance of the capacitor sample at −25° C. to 85° C. was measured. The rate of change (unit: %) from the capacitance at 20° C. to the capacitance at −25° C. and 85° C. was calculated. In the present examples, a rate of change of capacitance of −15% to 15% was deemed good.

TABLE 1

| | Amount with respect to 100 parts by mol of “M” in | | | | | | | | | | | | | | | | |
|---|---|---|---|---|---|---|---|---|---|---|---|---|---|---|---|---|---|
| | terms of metal element [part by mol] | | | | | | | | | | | | | | | | |
| | First | Second | | | | | | Third | | | 4A | | 4B | 5A | | Sixth | |
| | sub- | sub- | | | | | | sub- | | | sub- | | sub- | sub- | | sub- | |
| Sample | component | component | | | | | | component | | | component | | component | component | | component | |
| No. | Mg | Nb | Mo | Ta | W | Sn | Bi | Sm | Nd | La | Fe | Mn | Co | Sr | Ba | Al | Si |
| 1 | 0.00 | 2.31 | 0.00 | 0.00 | 0.00 | 0.00 | 0.00 | 0.89 | 0.00 | 0.00 | 0.19 | 0.21 | 0.61 | 0.45 | 0.09 | 0.55 | 0.23 |
| 2 | 0.00 | 2.31 | 0.00 | 0.00 | 0.00 | 0.00 | 0.00 | 0.89 | 0.00 | 0.00 | 0.19 | 0.64 | 0.20 | 0.45 | 0.09 | 0.55 | 0.23 |
| 3 | 0.00 | 2.31 | 0.00 | 0.00 | 0.00 | 0.00 | 0.00 | 0.89 | 0.00 | 0.00 | 0.38 | 0.43 | 0.20 | 0.45 | 0.09 | 0.55 | 0.23 |
| 4 | 0.00 | 2.31 | 0.00 | 0.00 | 0.00 | 0.00 | 0.00 | 0.89 | 0.00 | 0.00 | 0.38 | 0.23 | 0.40 | 0.45 | 0.09 | 0.55 | 0.23 |
| 5 | 0.00 | 2.31 | 0.00 | 0.00 | 0.00 | 0.00 | 0.00 | 0.89 | 0.00 | 0.00 | 0.05 | 0.43 | 0.56 | 0.45 | 0.09 | 0.55 | 0.23 |
| 6 | 0.00 | 2.31 | 0.00 | 0.00 | 0.00 | 0.00 | 0.00 | 0.89 | 0.00 | 0.00 | 0.05 | 0.64 | 0.35 | 0.45 | 0.09 | 0.55 | 0.23 |
| 7 | 0.00 | 2.31 | 0.00 | 0.00 | 0.00 | 0.00 | 0.00 | 0.89 | 0.00 | 0.00 | 0.38 | 0.64 | 0.00 | 0.45 | 0.09 | 0.55 | 0.23 |
| 8 | 0.00 | 2.31 | 0.00 | 0.00 | 0.00 | 0.00 | 0.00 | 0.89 | 0.00 | 0.00 | 0.57 | 0.43 | 0.00 | 0.45 | 0.09 | 0.55 | 0.23 |
| 9 | 0.00 | 2.31 | 0.00 | 0.00 | 0.00 | 0.00 | 0.00 | 0.89 | 0.00 | 0.00 | 0.57 | 0.21 | 0.20 | 0.45 | 0.09 | 0.55 | 0.23 |
| 10 | 0.00 | 2.31 | 0.00 | 0.00 | 0.00 | 0.00 | 0.00 | 0.89 | 0.00 | 0.00 | 0.60 | 0.15 | 0.20 | 0.45 | 0.09 | 0.55 | 0.23 |
| 11 | 0.00 | 2.31 | 0.00 | 0.00 | 0.00 | 0.00 | 0.00 | 0.89 | 0.00 | 0.00 | 0.80 | 0.01 | 0.20 | 0.45 | 0.09 | 0.55 | 0.23 |
| 12 | 0.00 | 0.00 | 2.00 | 0.00 | 0.00 | 0.00 | 0.00 | 0.95 | 0.00 | 0.00 | 0.38 | 0.43 | 0.20 | 0.45 | 0.09 | 0.55 | 0.23 |
| 13 | 0.00 | 0.00 | 0.00 | 2.20 | 0.00 | 0.00 | 0.00 | 0.85 | 0.00 | 0.00 | 0.38 | 0.43 | 0.20 | 0.45 | 0.09 | 0.55 | 0.23 |
| 14 | 0.00 | 0.00 | 0.00 | 0.00 | 1.95 | 0.00 | 0.00 | 0.80 | 0.00 | 0.00 | 0.38 | 0.43 | 0.20 | 0.45 | 0.09 | 0.55 | 0.23 |
| 15 | 0.00 | 2.20 | 0.00 | 0.00 | 0.00 | 0.00 | 0.00 | 0.00 | 0.75 | 0.00 | 0.38 | 0.43 | 0.20 | 0.45 | 0.09 | 0.55 | 0.23 |
| 16 | 0.00 | 2.10 | 0.00 | 0.00 | 0.00 | 0.00 | 0.00 | 0.00 | 0.00 | 0.83 | 0.38 | 0.43 | 0.20 | 0.45 | 0.09 | 0.55 | 0.23 |
| 17 | 0.00 | 0.02 | 0.00 | 0.00 | 0.00 | 1.21 | 0.81 | 0.00 | 0.00 | 0.09 | 0.57 | 0.64 | 0.00 | 0.30 | 0.09 | 0.00 | 0.08 |

TABLE 2

| Sample | Mn/ | Main component | (Ba + Ca + Sr)/ | εr | tanδ | IR | ACVB | TC (−25° C.) | TC (+85° C.) |
|---|---|---|---|---|---|---|---|---|---|
| No. | (Fe + Mn) | raw material A/M | (Ti + Zr) | [—] | [%] | [MΩ] | [kV/mm] | [%] | [%] |
| 1 | 0.53 | 0.997 | 1.002 | 3914 | 1.59 | 1.1E+06 | 5.3 | −2.7 | −7.4 |
| 2 | 0.77 | 0.997 | 1.002 | 4060 | 1.57 | 8.5E+05 | 4.6 | −3.2 | −10.0 |
| 3 | 0.53 | 0.997 | 1.002 | 4189 | 1.98 | 3.8E+05 | 6.1 | −3.0 | −11.5 |
| 4 | 0.38 | 0.997 | 1.002 | 3734 | 1.42 | 1.1E+04 | 6.4 | −3.3 | −6.6 |
| 5 | 0.90 | 0.997 | 1.002 | 4003 | 1.72 | 4.5E+05 | 4.2 | −2.6 | −8.2 |
| 6 | 0.93 | 0.997 | 1.002 | 4065 | 1.58 | 3.6E+05 | 4.2 | −3.5 | −9.2 |
| 7 | 0.63 | 0.997 | 1.002 | 4378 | 1.77 | 1.9E+06 | 6.1 | −5.2 | −13.2 |
| 8 | 0.43 | 0.997 | 1.002 | 3935 | 1.55 | 4.1E+03 | 6.6 | −6.8 | −9.9 |
| 9 | 0.27 | 0.997 | 1.002 | 3659 | 1.51 | 3.2E+03 | 6.3 | −5.6 | −6.8 |
| 10 | 0.20 | 0.997 | 1.002 | 3771 | 2.10 | 1.2E+03 | 6.2 | −7.0 | −4.6 |
| 11 | 0.01 | 0.997 | 1.002 | 3624 | 4.19 | 8.5E+01 | 6.2 | −8.4 | 5.8 |
| 12 | 0.53 | 0.997 | 1.002 | 4235 | 1.98 | 3.4E+05 | 6.1 | −3.2 | −10.2 |
| 13 | 0.53 | 0.997 | 1.002 | 4105 | 1.94 | 3.0E+05 | 5.9 | −2.9 | −9.8 |
| 14 | 0.53 | 0.997 | 1.002 | 4063 | 1.74 | 3.2E+05 | 5.8 | −3.3 | −9.6 |
| 15 | 0.53 | 0.997 | 1.002 | 3937 | 2.04 | 2.3E+05 | 6.3 | −2.5 | −10.1 |
| 16 | 0.53 | 0.997 | 1.002 | 3895 | 1.92 | 1.9E+05 | 6.0 | −3.5 | −9.7 |
| 17 | 0.53 | 0.997 | 1.001 | 3641 | 0.97 | 3.8E+05 | 6.1 | −5.8 | −5.6 |

TABLE 3

| | Amount with respect to 100 parts by mol of “M” in terms of metal element [part by mol] | | | | | | | | | |
|---|---|---|---|---|---|---|---|---|---|---|
| | First | Second | Third | 4A | | 4B | 5A | | Sixth | |
| Sample | subcomponent | subcomponent | subcomponent | subcomponent | | subcomponent | subcomponent | | subcomponent | |
| No. | Mg | Nb | Sm | Fe | Mn | Co | Sr | Ba | Al | Si |
| 21 | 0.00 | 1.96 | 0.52 | 0.57 | 0.64 | 0.40 | 0.45 | 0.09 | 0.55 | 0.23 |
| 22 | 0.00 | 2.31 | 0.52 | 0.57 | 0.64 | 0.40 | 0.45 | 0.09 | 0.55 | 0.23 |
| 23 | 0.00 | 2.66 | 0.52 | 0.57 | 0.64 | 0.40 | 0.45 | 0.09 | 0.55 | 0.23 |
| 24 | 0.00 | 0.00 | 0.52 | 0.57 | 0.64 | 0.40 | 0.45 | 0.09 | 0.55 | 0.23 |
| 25 | 0.00 | 8.00 | 0.89 | 0.38 | 0.43 | 0.20 | 0.45 | 0.09 | 0.55 | 0.23 |
| 26 | 0.00 | 11.00 | 0.89 | 0.38 | 0.43 | 0.20 | 0.45 | 0.09 | 0.55 | 0.23 |

TABLE 4

| Sample | Mn/ | Main component | (Ba + Ca + Sr)/ | εr | tanδ | IR | ACVB | TC (−25° C.) | TC (+85° C.) |
|---|---|---|---|---|---|---|---|---|---|
| No. | (Fe + Mn) | raw material A/M | (Ti + Zr) | [—] | [%] | [MΩ] | [kV/mm] | [%] | [%] |
| 21 | 0.530 | 0.997 | 1.002 | 3984 | 0.79 | 1.6E+05 | 6.4 | −5.6 | −4.2 |
| 22 | 0.530 | 0.997 | 1.002 | 3829 | 0.84 | 1.5E+05 | 6.3 | −6.1 | −3.4 |
| 23 | 0.530 | 0.997 | 1.002 | 3633 | 0.92 | 1.4E+05 | 5.8 | −5.8 | −3.3 |
| 24 | 0.530 | 0.997 | 1.002 | 4634 | 0.95 | 1.0E+05 | 5.6 | −6.1 | −3.6 |
| 25 | 0.530 | 0.997 | 1.002 | 1803 | 1.54 | 1.3E+05 | 5.6 | −4.7 | −9.4 |
| 26 | 0.530 | 0.997 | 1.002 | 1040 | 1.54 | 1.3E+05 | 5.6 | −4.7 | −12.6 |

TABLE 5

| | Amount with respect to 100 parts by mol of “M” in terms of metal element [part by mol] | | | | | | | | | |
|---|---|---|---|---|---|---|---|---|---|---|
| | First | Second | Third | 4A | | 4B | 5A | | Sixth | |
| Sample | subcomponent | subcomponent | subcomponent | subcomponent | | subcomponent | subcomponent | | subcomponent | |
| No. | Mg | Nb | Sm | Fe | Mn | Co | Sr | Ba | Al | Si |
| 31 | 0.00 | 2.31 | 0.89 | 0.57 | 0.64 | 0.40 | 0.45 | 0.09 | 0.55 | 0.23 |
| 32 | 0.00 | 2.31 | 0.71 | 0.57 | 0.64 | 0.40 | 0.45 | 0.09 | 0.55 | 0.23 |
| 33 | 0.00 | 2.31 | 0.52 | 0.57 | 0.64 | 0.40 | 0.45 | 0.09 | 0.55 | 0.23 |
| 34 | 0.00 | 2.66 | 0.41 | 0.57 | 0.64 | 0.40 | 0.45 | 0.09 | 0.00 | 0.23 |
| 35 | 0.00 | 2.31 | 0.01 | 0.57 | 0.64 | 0.40 | 0.45 | 0.09 | 0.55 | 0.23 |
| 36 | 0.00 | 2.31 | 0.00 | 0.38 | 0.43 | 0.20 | 0.45 | 0.09 | 0.55 | 0.23 |
| 37 | 0.00 | 2.31 | 2.10 | 0.38 | 0.43 | 0.20 | 0.45 | 0.09 | 0.55 | 0.23 |

TABLE 6

| Sample | Mn/ | Main component | (Ba + Ca + Sr)/ | εr | tanδ | IR | ACVB | TC (−25° C.) | TC (+85° C.) |
|---|---|---|---|---|---|---|---|---|---|
| No. | (Fe + Mn) | raw material A/M | (Ti + Zr) | [—] | [%] | [MΩ] | [kV/mm] | [%] | [%] |
| 31 | 0.530 | 0.997 | 1.002 | 3679 | 0.86 | 2.1E+05 | 5.6 | −5.0 | −7.3 |
| 32 | 0.530 | 0.997 | 1.002 | 3688 | 0.82 | 2.2E+05 | 6.1 | −5.9 | −5.4 |
| 33 | 0.530 | 0.997 | 1.002 | 3739 | 0.74 | 1.5E+05 | 6.2 | −6.2 | −3.6 |
| 34 | 0.530 | 0.997 | 1.002 | 3658 | 0.71 | 4.4E+05 | 6.1 | −6.1 | −2.2 |
| 35 | 0.530 | 0.997 | 1.002 | 3738 | 0.58 | 1.0E+05 | 5.6 | −11.1 | 3.1 |
| 36 | 0.530 | 0.997 | 1.002 | 3945 | 0.89 | 1.3E+05 | 5.6 | −15.4 | 6.2 |
| 37 | 0.529 | 0.997 | 1.002 | 4009 | 2.42 | 1.3E+05 | 5.6 | 7.3 | −30.6 |

TABLE 7

| | Amount with respect to 100 parts by mol of “M” in terms of metal element [part by mol] | | | | | | | | | | |
|---|---|---|---|---|---|---|---|---|---|---|---|
| | First | Second | Third | 4A | | 4B | 4A subcomponent + | 5A | | Sixth | |
| Sample | subcomponent | subcomponent | subcomponent | subcomponent | | subcomponent | 4B subcomponent | subcomponent | | subcomponent | |
| No. | Mg | Nb | Sm | Fe | Mn | Co | Co + Fe + Mn | Sr | Ba | Al | Si |
| 41 | 0.00 | 2.31 | 0.89 | 0.57 | 0.64 | 0.40 | 1.62 | 0.45 | 0.09 | 0.55 | 0.23 |
| 42 | 0.00 | 2.31 | 0.89 | 0.57 | 0.64 | 0.61 | 1.82 | 0.45 | 0.09 | 0.55 | 0.23 |
| 43 | 0.00 | 2.31 | 0.89 | 0.57 | 0.64 | 0.81 | 2.02 | 0.45 | 0.09 | 0.55 | 0.23 |
| 44 | 0.00 | 2.66 | 0.52 | 0.01 | 0.01 | 0.01 | 0.03 | 0.45 | 0.09 | 0.55 | 0.23 |
| 45 | 0.00 | 2.31 | 0.89 | 0.003 | 0.003 | 0.003 | 0.009 | 0.45 | 0.09 | 0.55 | 0.23 |
| 46 | 0.00 | 2.31 | 0.89 | 1.20 | 1.20 | 0.60 | 3.00 | 0.45 | 0.09 | 0.55 | 0.23 |

TABLE 8

| Sample | Mn/ | Main component | (Ba + Ca + Sr)/ | εr | tanδ | IR | ACVB | TC (−25° C.) | TC (+85° C.) |
|---|---|---|---|---|---|---|---|---|---|
| No. | (Fe + Mn) | raw material A/M | (Ti + Zr) | [—] | [%] | [MΩ] | [kV/mm] | [%] | [%] |
| 41 | 0.530 | 0.997 | 1.002 | 3596 | 0.99 | 3.3E+05 | 5.9 | −1.6 | −8.6 |
| 42 | 0.530 | 0.997 | 1.002 | 3630 | 0.85 | 4.1E+05 | 5.4 | −1.3 | −8.1 |
| 43 | 0.530 | 0.997 | 1.002 | 3591 | 0.75 | 3.6E+05 | 6.1 | −0.7 | −7.8 |
| 44 | 0.500 | 0.997 | 1.002 | 4098 | 1.88 | 3.0E+05 | 5.6 | −11.3 | −12.3 |
| 45 | 0.500 | 0.997 | 1.002 | 4241 | 2.02 | 3.2E+05 | 5.7 | −7.7 | −19.1 |
| 46 | 0.500 | 0.997 | 1.002 | 3376 | 1.03 | 3.3E+04 | 5.7 | 0.7 | 18.4 |

TABLE 9

| | Amount with respect to 100 parts by mol of “M” in terms of metal element [part by mol] | | | | | | | | | | | | | |
|---|---|---|---|---|---|---|---|---|---|---|---|---|---|---|
| | | | | | | | 5A | | | | Sixth | | | |
| | | | | | | | subcomponent | | | | subcomponent | | | |
| | First | Second | Third | 4A | | 4B | | | | Sr + | | | | Al + |
| Sample | subcomponent | subcomponent | subcomponent | subcomponent | | subcomponent | | | | Ba + | | | | Si + |
| No. | Mg | Nb | Sm | Fe | Mn | Co | Sr | Ba | Ca | Ca | Al | Si | B | B |
| 51 | 0.00 | 2.31 | 0.52 | 0.57 | 0.64 | 0.40 | 0.45 | 0.00 | 0.00 | 0.45 | 0.55 | 0.23 | 0.00 | 0.78 |
| 52 | 0.00 | 2.31 | 0.52 | 0.57 | 0.64 | 0.40 | 0.45 | 0.09 | 0.00 | 0.54 | 0.55 | 0.23 | 0.00 | 0.78 |
| 53 | 0.00 | 2.31 | 0.52 | 0.57 | 0.64 | 0.40 | 0.45 | 0.19 | 0.00 | 0.64 | 0.55 | 0.23 | 0.00 | 0.78 |
| 54 | 0.00 | 2.31 | 0.52 | 0.57 | 0.64 | 0.40 | 0.45 | 0.19 | 0.19 | 0.82 | 0.55 | 0.23 | 0.00 | 0.78 |
| 55 | 0.00 | 2.31 | 0.52 | 0.57 | 0.64 | 0.40 | 0.01 | 0.00 | 0.00 | 0.01 | 0.55 | 0.23 | 0.00 | 0.78 |
| 56 | 0.00 | 2.31 | 0.52 | 0.57 | 0.64 | 0.40 | 1.50 | 0.40 | 0.50 | 2.40 | 0.55 | 0.23 | 0.00 | 0.78 |
| 57 | 0.00 | 2.31 | 0.52 | 0.57 | 0.64 | 0.40 | 0.45 | 0.09 | 0.00 | 0.54 | 0.55 | 0.23 | 0.05 | 0.83 |

TABLE 10

| Sample | Mn/ | Main component | (Ba + Ca + Sr)/ | εr | tanδ | IR | ACVB | TC (−25° C.) | TC (+85° C.) |
|---|---|---|---|---|---|---|---|---|---|
| No. | (Fe + Mn) | raw material A/M | (Ti + Zr) | [—] | [%] | [MΩ] | [kV/mm] | [%] | [%] |
| 51 | 0.530 | 0.997 | 1.002 | 3823 | 0.83 | 1.3E+05 | 6.2 | −5.9 | −3.3 |
| 52 | 0.530 | 0.997 | 1.002 | 3829 | 0.84 | 1.5E+05 | 6.3 | −6.1 | −3.4 |
| 53 | 0.530 | 0.997 | 1.003 | 3829 | 0.82 | 1.5E+05 | 6.4 | −6.1 | −3.2 |
| 54 | 0.530 | 0.997 | 1.005 | 3521 | 1.01 | 1.4E+05 | 6.2 | −5.8 | −2.9 |
| 55 | 0.530 | 0.997 | 0.997 | 3841 | 1.03 | 1.8E+05 | 6.0 | −18.4 | −26.3 |
| 56 | 0.530 | 0.997 | 1.021 | 2344 | 1.48 | 4.1E+03 | 5.1 | −7.3 | −5.6 |
| 57 | 0.530 | 0.997 | 1.002 | 3972 | 1.05 | 1.5E+05 | 6.1 | −5.3 | −3.2 |

TABLE 11

| | Amount with respect to 100 parts by mol of “M” in terms of metal element [part by mol] | | | | | | | | | | | | |
|---|---|---|---|---|---|---|---|---|---|---|---|---|---|
| | | | | | | | | | | Sixth | | | |
| | First | Second | Third | 4A | | 4B | 5A | | | subcomponent | | | |
| Sample | subcomponent | subcomponent | subcomponent | subcomponent | | subcomponent | subcomponent | | | | | | Al + |
| No. | Mg | Nb | Sm | Fe | Mn | Co | Sr | Ba | Ca | Al | Si | B | Si + B |
| 61 | 0.00 | 2.31 | 0.52 | 0.57 | 0.64 | 0.40 | 0.45 | 0.09 | 0.00 | 0.00 | 0.00 | 0.00 | 0.00 |
| 62 | 0.00 | 2.31 | 0.52 | 0.57 | 0.64 | 0.40 | 0.45 | 0.09 | 0.00 | 0.00 | 0.23 | 0.00 | 0.23 |
| 63 | 0.00 | 2.31 | 0.52 | 0.57 | 0.64 | 0.40 | 0.45 | 0.09 | 0.00 | 0.00 | 0.47 | 0.00 | 0.47 |
| 64 | 0.00 | 2.31 | 0.52 | 0.57 | 0.64 | 0.40 | 0.45 | 0.09 | 0.00 | 0.00 | 0.70 | 0.00 | 0.70 |

TABLE 12

| Sample | Mn/ | Main component | (Ba + Ca + Sr)/ | εr | tanδ | IR | ACVB | TC (−25° C.) | TC (+85° C.) |
|---|---|---|---|---|---|---|---|---|---|
| No. | (Fe + Mn) | raw material A/M | (Ti + Zr) | [—] | [%] | [MΩ] | [kV/mm] | [%] | [%] |
| 61 | 0.530 | 0.998 | 1.003 | 3809 | 0.95 | 2.7E+05 | 5.6 | −6.1 | −3.6 |
| 62 | 0.530 | 0.998 | 1.003 | 3788 | 0.77 | 1.6E+05 | 6.1 | −5.2 | −4.2 |
| 63 | 0.530 | 0.998 | 1.003 | 3816 | 0.77 | 1.1E+05 | 6.4 | −5.3 | −3.7 |
| 64 | 0.530 | 0.998 | 1.003 | 3843 | 0.78 | 1.0E+05 | 6.0 | −5.5 | −3.2 |

TABLE 13

| | Amount with respect to 100 parts by mol of “M” in terms of metal element [part by mol] | | | | | | | | | |
|---|---|---|---|---|---|---|---|---|---|---|
| | First | Second | Third | 4A | | 4B | 5A | | Sixth | |
| Sample | subcomponent | subcomponent | subcomponent | subcomponent | | subcomponent | subcomponent | | subcomponent | |
| No. | Mg | Nb | Sm | Fe | Mn | Co | Sr | Ba | Al | Si |
| 71 | 0.00 | 2.31 | 0.89 | 0.57 | 0.64 | 0.40 | 0.45 | 0.09 | 0.00 | 0.23 |
| 72 | 0.00 | 2.31 | 0.89 | 0.57 | 0.64 | 0.40 | 0.45 | 0.09 | 0.27 | 0.23 |
| 73 | 0.00 | 2.31 | 0.89 | 0.57 | 0.64 | 0.40 | 0.45 | 0.09 | 0.55 | 0.23 |

TABLE 14

| Sample | Mn/ | Main component | (Ba + Ca + Sr)/ | εr | tanδ | IR | ACVB | TC (−25° C.) | TC (+85° C.) |
|---|---|---|---|---|---|---|---|---|---|
| No. | (Fe + Mn) | raw material A/M | (Ti + Zr) | [—] | [%] | [MΩ] | [kV/mm] | [%] | [%] |
| 71 | 0.530 | 0.998 | 1.003 | 3912 | 1.18 | 1.6E+05 | 6.1 | −4.1 | −8.1 |
| 72 | 0.530 | 0.998 | 1.003 | 3703 | 1.10 | 1.8E+05 | 5.5 | −4.7 | −7.4 |
| 73 | 0.530 | 0.998 | 1.003 | 3679 | 0.86 | 2.1E+05 | 5.6 | −5.0 | −7.3 |

TABLE 15

| | Amount with respect to 100 parts by mol of “M” in terms of metal element [part by mol] | | | | | | | | | |
|---|---|---|---|---|---|---|---|---|---|---|
| | First | Second | Third | 4A | | 4B | 5A | | Sixth | |
| Sample | subcomponent | subcomponent | subcomponent | subcomponent | | subcomponent | subcomponent | | subcomponent | |
| No. | Mg | Nb | Sm | Fe | Mn | Co | Sr | Ba | Al | Si |
| 81 | 0.10 | 2.31 | 0.89 | 0.57 | 0.64 | 0.00 | 0.45 | 0.09 | 0.55 | 0.23 |
| 82 | 0.50 | 2.31 | 0.89 | 0.57 | 0.64 | 0.00 | 0.45 | 0.09 | 0.55 | 0.23 |

TABLE 16

| Sample | Mn/ | Main component | (Ba + Ca + Sr)/ | εr | tanδ | IR | ACVB | TC (−25° C.) | TC (+85° C.) |
|---|---|---|---|---|---|---|---|---|---|
| No. | (Fe + Mn) | raw material A/M | (Ti + Zr) | [—] | [%] | [MΩ] | [kV/mm] | [%] | [%] |
| 81 | 0.530 | 0.998 | 1.003 | 3850 | 1.2 | 5.5E+04 | 5.6 | −5.40 | −11.11 |
| 82 | 0.530 | 0.998 | 1.003 | 3260 | 1.2 | 1.5E+05 | 5.9 | −6.46 | −15.60 |

According to Tables 1 and 2, it was confirmed that, when the molar ratio {Mn/(Fe+Mn) } of Mn to the total of Fe and Mn in terms of the metal elements was 0.18 to 0.65 (Sample Nos. 1, 3, 4, 7 to 10, and 12 to 17), the value of the AC breakdown electric field was higher than when the molar ratio {Mn/(Fe+Mn)} was 0.77 (Sample No. 2), 0.90 (Sample No. 5), and 0.93 (Sample No. 6).

According to Tables 1 and 2, it was confirmed that, when the molar ratio {Mn/(Fe+Mn) } of Mn to the total of Fe and Mn in terms of the metal elements was 0.18 to 0.65 (Sample Nos. 1, 3, 4, 7 to 10, and 12 to 17), the insulation resistance was higher than when the molar ratio {Mn/(Fe+Mn)} was 0.77 (Sample No. 2) and 0.90 (Sample No. 5).

According to Tables 3 and 4, it was confirmed that, when the second subcomponent was included at 0 to 10 parts by mol in terms of a metal element (Sample Nos. 21 to 25), the relative permittivity was higher than when the second subcomponent was included at 11.00 parts by mol in terms of a metal element (Sample No. 26).

According to Tables 5 and 6, it was confirmed that, when the third subcomponent was included at 0.01 to 2 parts by mol in terms of a metal element (Sample Nos. 31 to 35), the temperature characteristics of capacitance was better than when the third subcomponent was not included (Sample No. 36) and was included at 2.10 parts by mol in terms of a metal element (Sample No. 37).

According to Tables 7 and 8, it was confirmed that, when the 4A subcomponent and the 4B subcomponent were included at 0.02 to 2.2 parts by mol in total in terms of the metal elements (Sample Nos. 41 to 44), the temperature characteristics of capacitance was better than when the 4A subcomponent and the 4B subcomponent were included at 0.009 part by mol (Sample No. 45) and at 3.00 parts by mol (Sample No. 46) in total in terms of the metal elements.

According to Tables 9 and 10, it was confirmed that, when the value of {(Ba+Ca+Sr)/(Ti+Zr)} of the dielectric ceramic composition was 0.98 to 1.02 (Sample Nos. 51 to 55 and 57), the relative permittivity was higher, the dielectric loss was lower, the insulation resistance was further higher, and the value of the AC breakdown electric field was further higher than when the value of {(Ba+Ca+Sr)/(Ti+Zr) } of the dielectric ceramic composition was 1.021 (Sample No. 56).

According to Tables 11 and 12, it was confirmed that, when the sixth subcomponent was included at 0.08 part by mol or more in terms of a metal element (Sample Nos. 62 to 64), the value of the AC breakdown electric field was further higher than when the sixth subcomponent was not included (Sample No. 61).

According to Tables 13 and 14, it was confirmed that including Al as the sixth subcomponent further increased the insulation resistance.

According to Tables 15 and 16, it was confirmed that, when the first subcomponent was included at less than 0.3 part by mol in terms of the metal element (Sample No. 81), the temperature characteristics of capacitance was better than when the first subcomponent was included at 0.5 part by mol in terms of the metal element (Sample No. 82).

### NUMERICAL REFERENCES

2 . . . ceramic capacitor
4 . . . protective resin
6, 8 . . . lead terminal
10 . . . dielectric layer
12, 14 . . . terminal electrode

What is claimed is:

1. A dielectric ceramic composition comprising main component grains having a perovskite structure represented by a formula AMO₃, wherein
“A” includes Ba;
“M” includes Ti;
the dielectric ceramic composition includes a 4A subcomponent;
the 4A subcomponent includes Fe and Mn; and
a molar ratio of Mn to a total of Fe and Mn in terms of a metal element is 0.18 to 0.65.

2. The dielectric ceramic composition according to claim 1, wherein
the dielectric ceramic composition further comprises 0 to 10 parts by mol of a second subcomponent with respect to 100 parts by mol of “M” in terms of a metal element; and
the second subcomponent includes at least one selected from the group consisting of Nb, Mo, Ta, W, Sn, and Bi.

3. The dielectric ceramic composition according to claim 1, wherein
the dielectric ceramic composition further comprises 0.01 to 2 parts by mol of a third subcomponent with respect to 100 parts by mol of “M” in terms of a metal element; and
the third subcomponent includes at least one selected from the group consisting of Sm, Nd, and La.

4. The dielectric ceramic composition according to claim 1, wherein
the dielectric ceramic composition further comprises a 4B subcomponent; and
the 4B subcomponent includes at least one selected from the group consisting of Co, Zn, Ni, and Cr.

5. The dielectric ceramic composition according to claim 1, wherein
the dielectric ceramic composition further comprises 0.02 to 2.2 parts by mol of the 4A subcomponent and a 4B subcomponent in total with respect to 100 parts by mol of “M” in terms of a metal element; and
the 4B subcomponent includes at least one selected from the group consisting of Co, Zn, Ni, and Cr.

6. The dielectric ceramic composition according to claim 1, wherein
the dielectric ceramic composition further comprises 0.08 part by mol or more of a sixth subcomponent with respect to 100 parts by mol of “M” in terms of a metal element; and
the sixth subcomponent includes at least one selected from the group consisting of Si, Al, and B.

7. The dielectric ceramic composition according to claim 1, wherein
a molar ratio of a total of Ba, Ca, and Sr to a total of Ti and Zr in terms of a metal element in the dielectric ceramic composition is 0.98 to 1.02.

8. The dielectric ceramic composition according to claim 7, wherein
the dielectric ceramic composition further comprises 0 to 3 parts by mol of a 5A subcomponent with respect to 100 parts by mol of “M” in terms of a metal element;
the 5A subcomponent includes at least one selected from the group consisting of Ba, Ca, and Sr;
the dielectric ceramic composition further comprises 0 to 2.5 parts by mol of a 5B subcomponent with respect to 100 parts by mol of “M” in terms of a metal element; and
the 5B subcomponent includes at least one selected from the group consisting of Ti and Zr.

9. The dielectric ceramic composition according to claim 1, wherein
the dielectric ceramic composition further comprises less than 0.3 part by mol of a first subcomponent with respect to 100 parts by mol of “M” in terms of a metal element; and
the first subcomponent is Mg.
